(19) United States
(12) Patent Application Publication
(10) Pub. No.: US 2026/0017845 A1
(43) Pub. Date: Jan. 15, 2026

(54) METHOD AND SYSTEM FOR FACIAL MASKING OF IMAGED SUBJECTS PERFORMING PHYSICAL ACTIVITIES

(71) Applicant: KINETISENSE INC., Medicine Hat (CA)

(72) Inventor: Ryan Daniel Comeau, Medicine Hat (CA)

(21) Appl. No.: 19/263,910

(22) Filed: Jul. 9, 2025

Related U.S. Application Data
(60) Provisional application No. 63/671,557, filed on Jul. 15, 2024.

(51) Int. Cl. G06T 11/00; G06T 7/246; G06V 10/62; G06V 10/77; G06V 20/20; G06V 40/16; G06V 40/20

(52) U.S. Cl. CPC G06T 11/00; G06T 7/251; G06V 20/20; G06V 40/167; G06V 40/23; G06T 2207/30012; G06T 2207/30201; G06V 10/62; G06V 10/7715

(57) ABSTRACT

Disclosed examples generally relate to a method and system for facial masking of imaged subjects performing physical activities. In some examples, the method includes analyzing an image frame of the subject performing a physical activity to identify one or more target joint types, as well as corresponding joint locations; determining joint axial separation distances between same joint types; determining size dimensions for a facial mask to apply to the imaged subject by: identifying the size dimensions of the facial mask in a previous image frame; comparing the joint separation distances in the image frame to the previous image frame; determining a degree of change of an axial distance metric; and adjusting the size dimensions of the facial mask in the previous image frame in proportion to the degree of change to generate updated size dimensions for the facial mask.

### CROSS-REFERENCE TO RELATED APPLICATION(S)

This application claims priority to, and benefit of, U.S. Provisional Patent Application No. 63/671,557, filed on Jul. 15, 2024, the contents of which are incorporated herein by reference in their entirety.

### FIELD

Various embodiments are described herein that generally relate to applying facial masking to images, and in particular, to a method and system for facial masking of imaged subjects performing physical activities (e.g., exercise or other fitness activities). Disclosed examples can be performed in real-time, or near real-time.

### BACKGROUND

In rehabilitation and sports applications, motion capture is often applied for biomechanical assessment and feedback. This includes using motion capture to detect movement dysfunctions—e.g., identifying compensatory movement patterns-with a view to correcting a subject's physical movements, identifying injuries, or otherwise developing early injury prevention strategies. Similarly, in workplace environments, motion capture is applied to monitor employees performing manual labor tasks (e.g., lifting objects) for tracking and early detection of physical movements prone to cause workplace injuries.

In many cases, motion capture is performed using two-dimensional (2D) or three-dimensional (3D) imaging sensors. These sensors capture singular image frames or multiple image frames (e.g., videos) of the subject, which are then analyzed to detect motion patterns. A challenge, however, is maintaining the privacy of the imaged subject, especially where the images and/or videos are accessible to third parties.

### SUMMARY

According to one broad aspect, there is disclosed a method for applying facial image masking of subjects performing physical activities, the method comprising: analyzing an image frame of the subject performing a physical activity to identify one or more target joint types, as well as corresponding joint locations, wherein the target joints comprise at least a pair of (i) shoulder joints, (ii) hip joints and (iii) spine joints; generating joint axis lines in the image frame that intersect the locations of identified joints of the same type, the axis lines comprising (i) a shoulder joint axis line, (ii) a hip joint axis line, and (iii) a spine joint axis line; determining joint axial separation distances between same joint types, wherein the separation distances are determined along a corresponding joint axis line; determining size dimensions for a facial mask to apply to the imaged subject by: identifying the size dimensions of the facial mask in a previous image frame; comparing the joint separation distances in the image frame to the previous image frame to determine a change; determining an axial distance metric, and a degree of change for that metric; and adjusting the size dimensions of the facial mask in the previous image frame in proportion to the degree of change to generate updated size dimensions for the facial mask; applying the facial mask to the image frame with the updated size dimensions to generate a masked image frame; and outputting the masked image frame.

In another broad aspect, there is provided a system for applying facial image masking of subjects performing physical activities, the system comprising: at least one processor configured for performing the above method.

In some examples, the method further comprises at least one imaging sensor coupled to the at least one processor.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example system for applying facial masking to images of subjects performing physical activities.

FIG. 2A is a process flow for an example method for applying facial image masking to an imaged subject performing a physical activity.

FIG. 2B is an example method for determining size dimensions for a facial mask.

FIG. 2C is a process flow for an example method for analyzing masked image frames to determine one or more physical activity parameters.

FIG. 2D is a process flow for another example method for analyzing masked image frames to determine one or more physical activity parameters.

FIGS. 3A-3C show an image frame of an example subject, and illustrating various identified joint types (FIG. 3A), joint type axis lines (FIG. 3B), and joint axis separation distances (FIG. 3C).

FIG. 4A are image frames of an example subject moving backward and forward relative to an imaging sensor.

FIG. 4B are images frames of an example subject performing a torso rotation exercise.

FIG. 4C is an image frame of an example subject performing a forward lean exercise.

FIGS. 4C and 4D are image frames of an example subject transitioning between a forearm plank and a side plank.

FIG. 5 is a simplified hardware block diagram of an example user device.

Further aspects and features of the example embodiments described herein will appear from the following description taken together with the accompanying drawings.

### DETAILED DESCRIPTION

Disclosed examples generally relate to a method and system for facial masking of imaged subjects performing physical activities (e.g., exercise activities or otherwise).

### I. GENERAL OVERVIEW

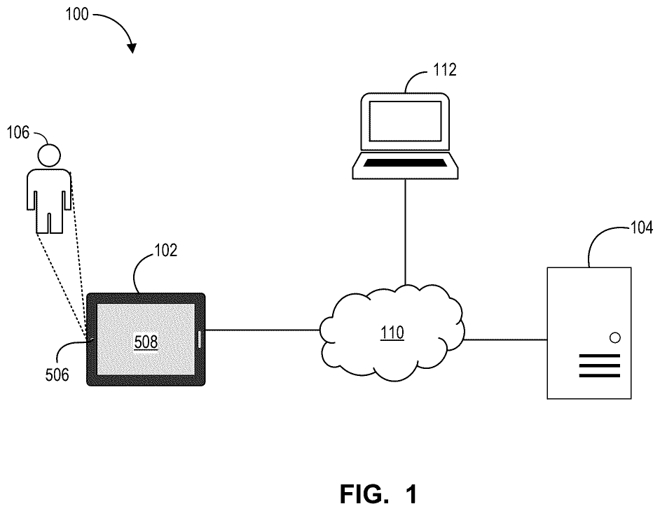

FIG. 1 shows a system 100 for facial masking of imaged subjects performing physical activities.

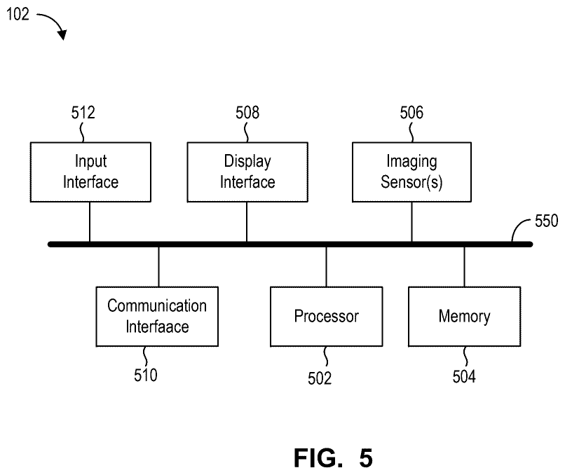

As shown, system 100 includes a user device 102. User device 102 can include any computing device in the art, and may include a mobile phone, tablet or the like. As explained in further detail, with reference to FIG. 5, user device 102 can generally include a processor 502 coupled (e.g., via a bus 550) to a memory 504, imaging sensor(s) 506, and one or more of a display interface 508, a communication interface 510 and an input interface 512.

Continuing with reference to FIG. 1, while only a single user device 102 is shown, in other examples there may be more than one user device. In some examples, user device 102 is coupled to one or more servers 104 and/or external computing devices 112, via communication network 110.

In use, user device 102 is operated to capture one or more image frames (e.g., a video) of a subject 106. The image frames may be captured using the imaging sensor 506 of user device 102. The images are captured while the subject 106 is performing, for example, a physical activity such as a physical exercise (e.g. squat, deadlift, etc.) or other routine physical activity (e.g., walking or lifting objects).

Captured image frames are then processed to analyze the physical activity. For instance, this involves processing the images to detect movement dysfunctions, e.g., identifying compensatory movement patterns, or determining if the activity is performed with the correct form and/or posture. By way of example, U.S. Pat. No. 12,087,094 titled “METHODS AND SYSTEMS FOR HUMAN MOTION CAPTURE” to Comeau (hereinafter referenced as “Comeau”), the entire contents of which are incorporated herein by reference, describes various methods and systems for human motion capture, and further discloses automatic analysis of image frames to determine whether a physical activity conforms with pre-determined activity-specific rules.

A significant challenge with the system 100, however, is maintaining the privacy and anonymity of the subject 106, whose face is visible and identifiable in the captured image frames. The lack of privacy is particularly problematic if the images are transmitted and/or accessible to third parties. This includes where the images are transmitted to an external server 104 for further processing, analysis and/or storage. The images may also be transmitted in real time or near real time to an external computing device 112 associated with a user (e.g., a rehabilitation practitioner), who remotely observes the images to assess the subject's physical activity performance in real time or near real time (e.g., to identify motion dysfunction).

To this effect, data security and anonymity considerations are paramount in the digital healthcare ecosystem and may prevent images of the subject 106 from being stored or transmitted, such that they are accessible by third parties. For this reason, it is critical that the subject's face is masked prior to the captured image frames being stored and/or transmitted.

Existing techniques for facial masking often rely on image or video post-processing techniques. However, most post-processing techniques use complex facial recognition software which is computationally intensive and demands large processing capabilities. These complex algorithms cannot be applied “on the edge” of the network 110, and using smaller user devices 102 with lower computational power. For this reason, the captured image frames are typically transmitted to a more powerful external server 104, which is then able to apply the post-processing software. Privacy considerations, however, are not mitigated when identifiable image frames of the subject are transmitted over communication network 110 to external servers and/or computing devices. Further, transmitting image frames to external servers 104 does not permit for applying facial masking in real time or near real time.

More recently, user devices with greater processing capabilities have emerged on the market, and which are capable of applying complex facial masking software. Still, existing facial masking software-even when applied directly on user devices 102-are not capable of real-time or near real-time, frame-to-frame masking. This is because the processing complexity of the software results in lag or delay that is unable to keep track with the subject's facial location between rapidly generated image frames. This is especially problematic when the subject is performing “explosive” physical movements that demand the software rapidly track facial location between image frames and apply facial masking correctly.

In view of the foregoing, disclosed examples enable facial image masking of subjects performing physical activities, and using less computationally intensive methods. In at least one example, disclosed examples are applied in real time or near real time, as the image frames are captured by the user device 102. This may allow the masked images frames to be viewed, stored or transmitted in real time or near real time.

More generally, because disclosed examples use low computationally intensive techniques, they can be: (i) executed on user devices with low processing power, e.g., user device 102. This, in turn, enables applying facial image masking on the edge of the network, and prior to the image frames being stored and/or externally transmitted; and (ii) allows facial masking to be applied in real time or near real time, as each image frame is captured by the user device 102, and with minimal processing lag or delay. The low processing delay is exceptionally suited for facial tracking and masking when the imaged subject is performing physical activities with rapid or explosive movements. Use of low computationally intensive techniques also enables facial masking in images that include more than one subject, and without compounding processing demands for each additional imaged subject.

To this end, a key aspect of disclosed embodiments is they are adapted for applications involving detection of movement dysfunction in images. This is because the masking is only applied to the subject's head region, while leaving the remainder imaged region of the subject's body unmasked. This allows analysis of images of the subject's body to determine if the subject's physical form and/or posture is correct.

### II. EXAMPLE METHODS(S)

The following is a description of various exemplary methods relating to disclosed examples.

### (i.) General Method

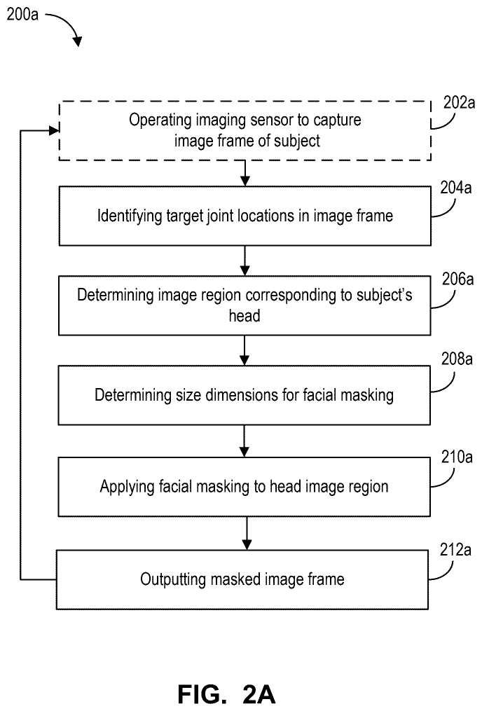

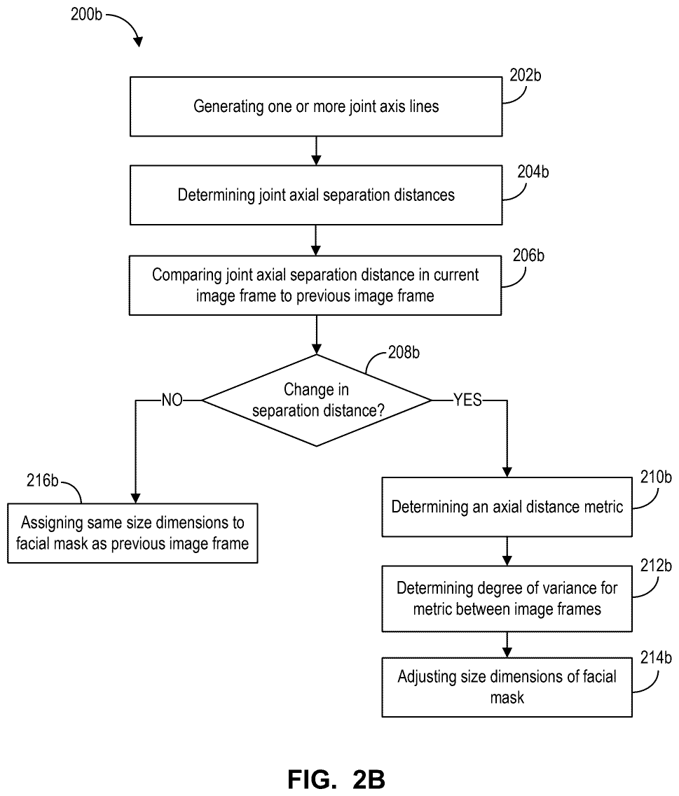

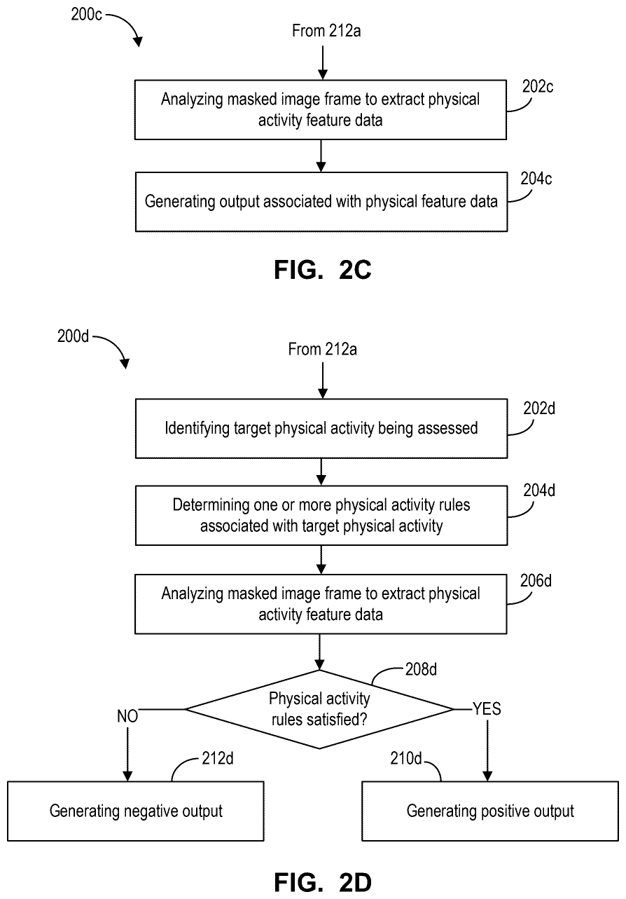

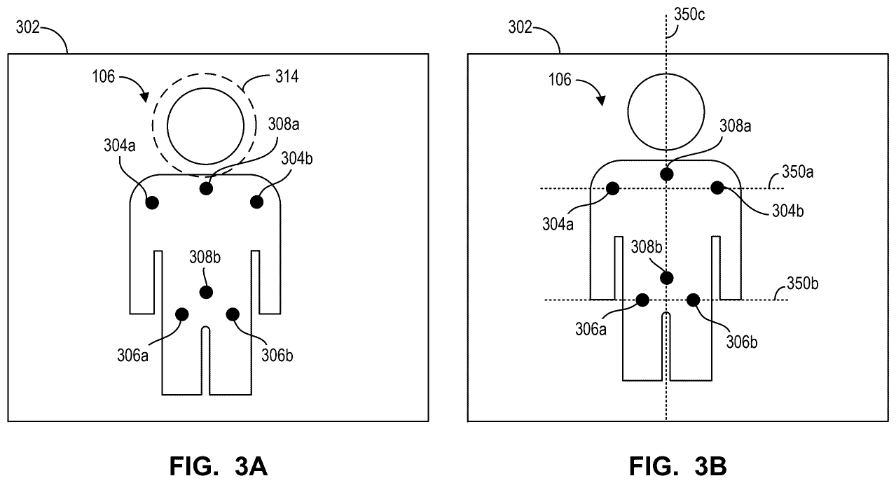

FIG. 2A shows a process flow for an example method 200a for applying facial masking to image frames. In at least one example, method 200a is performed by the processor 502 of the user device 102 (FIG. 5). Method 200a can be applied in real time or near real time, as image frames are captured.

At 202a, the imaging sensor 506, of the user device 106, is operated to capture an image frame of the subject 106. The image frame may be captured while the subject 106 is performing a physical activity, such as exercising (e.g., jumping jacks, squats or the like) or any other routine motion (e.g., walking, lifting objects, etc.).

In at least one example, the imaging sensor 506 is positioned to capture the entirety, or any portion, of the subject's front plane. In other words, at least some of a front portion of the subject's body is directed towards the imaging sensor 506, such that the subject's facial region (or any portion thereof) is visible to the imaging sensor 506.

In some examples, the imaging sensor 506 is a simple two-dimensional imaging sensor (e.g., a color or black and white camera) which generates 2D image frame data. In other examples, the imaging sensor 506 may comprise a three-dimensional sensor, such as a time of flight (ToF) sensor, e.g., a light detection and ranging (LiDAR) sensor. The 3D sensor can generate 3D image frame data, which includes point cloud data referenced to a coordinate system. In some cases, the imaging sensor 506 can generate both 2D and 3D image frame data, which are combined together.

At 204a, the captured image frame is processed and analyzed to identify one or more target joint types, as well as their location (e.g., pixel location) in the image frame. In some examples, the joint locations are identified in the image frame by 2D (x,y) coordinates, e.g., relative to an origin coordinate. If 3D image data is captured, the joint locations can be expressed in 3D (x,y,z) coordinates. In some examples, if 2D image data is captured, the 3D joint positions are determined by applying a triangulation model as described in Comeau.

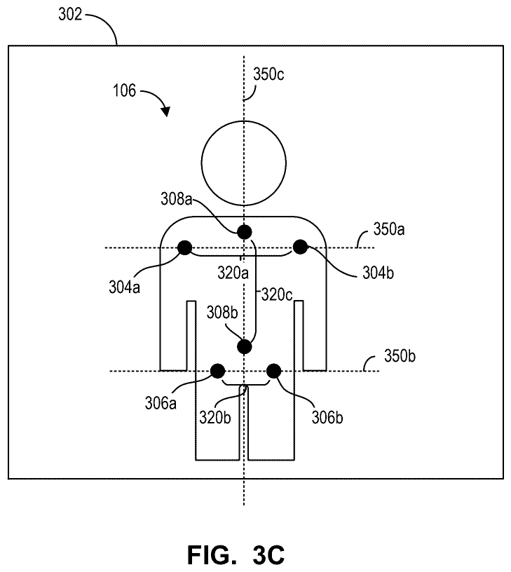

FIG. 3A shows an example 2D image frame 302 captured of a subject 106 performing a physical activity, with their frontal plane visible. As shown, the image frame is analyzed to identify target joint types 304-308, and their corresponding location in the image frame.

The target joint types, identified at act 204a, can comprise: (i) shoulder joints 304, including the right shoulder joint 304a and left shoulder joint 304b; (ii) hip joints 306, including the right hip joint 306a and left hip joint 306b; and (iii) spine joints 308, including at least two joints along the spine, such as the sternal notch 308a and the spine base 308b. Alternatively, or in addition, the spine joints 308 can include the sternal notch 308a and any other spine joint other than spine base 308b. The significance of selecting these specific joints is explained in greater detail herein.

In some examples, the target joints 304-308 are automatically identified and localized in the image frame by applying a skeletal image processing technique. Various skeletal tracking software development kit (SDK) known in the art can be used, including Microsoft™ Kinect™ SDK, Intel™ Cubemos™ skeletal tracking, and Apple™ ARKit. The SDKs can be stored on a memory 504 of the user device 102 (FIG. 2A).

Continuing with reference to FIG. 2A, at 206a, based on the identified target joints and corresponding locations—the system can determine an imaging region corresponding to the relative position of the subject's head. For instance, in the image frame 302 in FIG. 3A, this corresponds to the image region 314 (otherwise referred to herein as the “head image region”).

In at least one example, as shown in FIG. 3B, the head image region 314 is determined by: (i) generating a linear spine axis 350c intersecting each of the spine joints 308a, 308b (e.g., via acts 202b and 204b in FIG. 2B, as discussed later); and (ii) defining the head image region 314 as the area or region located along the spine axis 350c, and directly above the sternal notch joint 308a. As used herein, “above” the sternal notch 310a refers to a direction along spine axis 350c, distal to the base spine joint 308b.

In a 2D image, the head image region 314 defines a 2D region within the image. Alternatively, in a 3D image, the head image region 314 defines a 3D region within the image.

At 208a, in order to apply the facial mask to the head image region 314, the correct size dimensions for the facial mask are determined. The size dimensions are determined with a view to selectively masking only the facial region (or head region), and without occluding the remainder of the subject's imaged body. The method for determining the size dimensions of the facial mask is discussed in further detail in FIG. 2B.

At 210a, the facial mask, with the corresponding size dimensions determined at 208a, is applied to the head image region 314.

Any form of image masking technique can be applied at 210a, including techniques that alter the underlying image data (e.g., blurring, pixelation, color distortion, or blacking out the region) and those that involve superimposing a visual element (e.g., overlaying a solid shape, pattern, or translucent region to obscure the facial area without modifying the original pixel values). The mask can take any desired two-dimensional or three-dimensional shape (e.g., circle, square, ellipse, rectangle, polygon, or sphere). For instance, in the case of a 3D image frame at 202a, a corresponding 3D facial mask may be applied, such as a volumetric sphere or box enclosing the head region.

In at least one example, the facial mask is applied as a layer over the original image frame. In other examples, the facial mask is applied directly to the image frame, such as by distorting the image frame itself.

At 212a, the masked image frame—comprising the original image frame with the applied facial mask—is output. Various outputs are generatable at 212a: for instance, the masked image frame can be stored on a memory 504 of the user device 102 for subsequent processing and/or transmission to external devices. It can also be displayed on a display 508 of the user device 102, such as in real time or near real time.

In other examples, the output at 212a comprises transmitting the masked image frame externally (e.g., via network 110), such as to external cloud server 104 and/or computing device 112, such as for storage and/or further processing. The masked image frames may be transmitted in real time or near real time to the computing device 112. This can allow a user of the computing device 112 (e.g., a rehabilitation practitioner) to monitor, in real time or near real time, performance of the physical activities by the subject 106, all the while maintaining the subject's privacy in the masked image frames displayed to the user of computing device 112.

In at least one example, the masked image frame is retrievable from the external computing device, and once retrieved, the system automatically removes the image mask. Once the image frame is retransmitted to the external computing device, the mask is reapplied.

It is also possible that the masked image frames are processed before or after being transmitted from user device 102. For example, image processing techniques may be applied to the masked image frames to automatically determine if the subject is performing a physical activity correctly. This includes applying the image processing techniques described in Comeau, which are incorporated herein by reference.

In at least one example, the output generated at 212a for each image frame can include “joint analysis data”. The joint analysis data can include the data generated during the process of generating the masked image frame. In at least one example, the joint analysis data includes one or more of: (i) joint axis lines 350, (ii) joint separation distances 320 and (iii) joint positions 304-308, in respect of that masked image frame.

The joint analysis data may be associated in any manner with the masked image frame. For example, the joint analysis data may be embedded directly into the respective masked image frame. In other examples, it may be stored separately, but associated with the masked image frame, e.g., by some identifier. In still other examples, the joint analysis data is overlaid over the image frame, such as to generate a visually overlaid output. For example, the image frame can be overlaid with the joint axial lines 350.

In view of the foregoing, when the image frame is stored or transmitted, it can be stored or transmitted in association with the respective joint analysis data. An advantage of this is that the image frame is retrievable or accessible on a separate computing device and/or at a subsequent time, with the joint analysis data made available. This can allow the masked image frame to be analyzed, for instance, to evaluate the anonymized subject's performance of a physical activity.

By way of example, in one application, the external computing device 112 (FIG. 1) can receive the masked image frame, with the associated joint analysis data. External computing device 112 may be associated with a rehabilitation practitioner. The external computing device 112 may display the joint analysis data to the user (e.g., the rehabilitation practitioner) in conjunction with the masked image frame. This allows the user to view the masked image frame, and use the joint analysis data to conduct further analysis on the subject's performance of a physical activity, e.g. to diagnose movement dysfunctions.

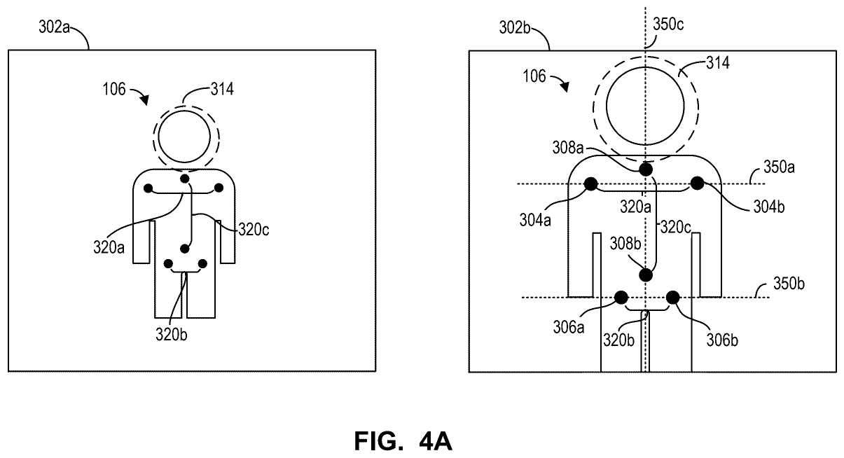

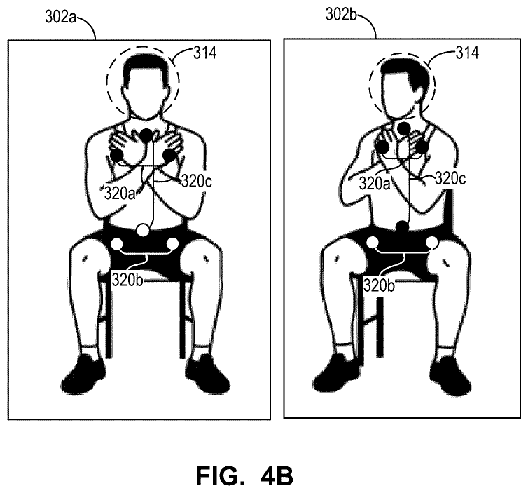

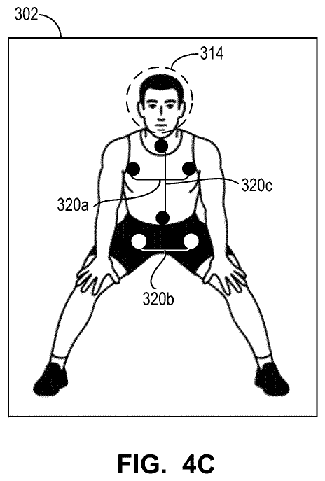

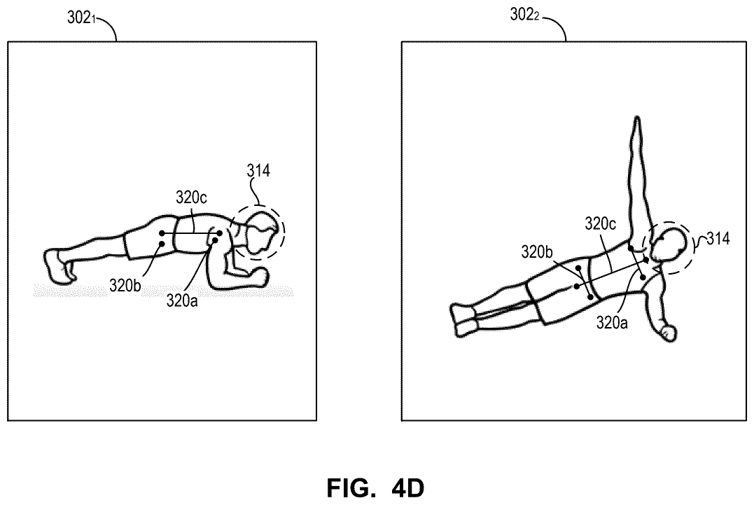

In some examples, the practitioner using computing device 112 can view a masked image frame with visually overlaid joint axis line (e.g., similar to FIG. 3B). The practitioner can use this information to analyze the subject's motion by observing, for instance, if specific joint axis lines are aligned in the correct manner. For example, in FIG. 4C, if the subject is performing a correct forward lean, it is expected that the shoulder axis line 350a should be generally aligned and parallel with the hip axis line 320b. Accordingly, the practitioner can visually observe the joint axis lines to determine if they are correctly orientated for the given activity. In view of this, the joint analysis data can allow for manual observation and assessment of physical activity performance.

In other examples, by associating the joint analysis data with masked image frames—the joint analysis data can also be used to perform an automated computerized analysis on the subject. Examples of such methods are described in further detail in FIGS. 2C and 2D (as described below). To this effect, method 200a can iterate over each new image frame received. In this manner, method 200a can output a plurality of masked image frames corresponding to a plurality of input image frames of the subject.

In some examples, act 212a is only applied after all masked image frames are generated. For example, the output can correspond to a video comprising a plurality of masked image frames. In other examples, acts 204a-212a may only be applied after the fact, i.e., after all image frames are captured.

In still other cases, it is also possible that method 200a is performed without necessarily operating the imaging sensor at 202a. For example, it is possible that method 200a is applied to previously captured image frames, e.g., retrieved from memory storage. In this case, act 202a is simply involves retrieving or accessing the image frame from memory or any other source.

### (ii.) Determining Size Dimensions for Facial Mask

FIG. 2B shows an example method 200b for determining the size dimensions for the facial mask applied at act 208a of method 200a (FIG. 2A). In at least one example, method 200b is performed by the processor 502 of the user device 102.

At 202b, based on the target joints identified in the image frame (204a in FIG. 2A), one or more same joint axis lines are generated. This is shown by way of example in FIG. 3B, which shows one or more generated joint axis lines 350a-350c. Each axis line 350 is generated to intersect joints of the same type. For example, these include: (i) joint axis line 350a, intersecting the shoulder joints 304a, 304b; (ii) joint axis line 350b, intersecting the hip joints 306a, 306b and (iii) joint axis line 350c, intersecting the spine joints 308a, 308b. The joint axis lines 350 are generated based on the known type and location of the joints, as determined at act 204a in FIG. 2A.

In cases where 2D images are being analyzed, the joint axis lines 350 can extend in 2D space. In other examples, where 3D image frames are being analyzed, the joint axis lines can extend in 3D space.

In some cases, the generated joint axis lines are overlaid over the image frame to intersect the relevant joints (e.g., FIG. 3B).

At 204b, a separation distance between each pair of joints of the same type is determined (also referred to herein as the “joint axial separation distance”). The separation distance between each two joints of the same type is determined along the corresponding joint axis line 350.

FIG. 3C exemplifies different axial separation distances 320 determined between different joint pairs. As shown, the separation distances 320 include: (i) a shoulder axial distance 320a between the shoulder joints 304a, 304b, as determined along the shoulder axis line 350a; (ii) a hip axial distance 320b between the hip joints 306a, 306b, as determined along the hip axis line 350b; and (iii) a spine axial distance 320c between the spine joints 308a, 308b, as determined along the spine axis line 350c.

In at least one example, the axial distances 320 are determined based on the pixel locations of each pair of joints. For example, the system can determine image pixel coordinates (e.g., x, y coordinates in 2D, or x, y, z coordinates in 3D) for each joint, and subtract the difference to determine the axial distances 320. In some examples, a Euclidean distance is determined.

Continuing with reference to FIG. 2B, at 206b, each of the joint axial separation distances 320a-320c determined in the current image frame, is compared to the corresponding distances 320 determined in a previous image frame of the same subject. The previous image frame can be the frame immediately preceding the current image frame temporally, or otherwise, any other prior image frame, e.g., in a temporal sense.

At 208b, a determination is made as to whether any of the separation distances has changed or varied between the image frames compared at 206b. This may involve determining if the separation distances has changed or varied beyond some pre-determined threshold (e.g., a positive or negative change). A change in a separation distance indicates that the subject has moved in the image frame. If the subject has moved in the image frame, it is likely their head is occupying more or less space in the image frame, and therefore, the size of the facial mask requires adjustment accordingly to mask the subject's head region 314.

If a change is determined in one or more of the joint axial separation distances 320, then at 210b, then an axial distance metric is determined.

In at least one example, the axial distance metric is determined (or identified) as the separation distance with the largest change. For instance, in FIG. 3C, this can be any one of the shoulder joint distance 320a, hip joint distance 320b or spine joint distance 320c. If all joints are varied by an equal amount, then any of the joint distances 320 can be identified and selected at act 210b.

In other examples, the axial distance metric is determined as an averaging of the axial separation distances, or an averaging of the axial distances which have changed between image frames. In still other examples, the axial distance metric can represent any combination or sub combination of the axial separation distances.

At 212b, the degree of variance (or degree of change) of the axial distance metric between image frames is determined. For instance, this can be the degree or change for the joint axial separation distance 320, identified in act 210b, as having the largest change. In this example, the degree of change can be determined as a percentage value, determined in accordance with Equation (1):

$$\% Change = \frac{A J {D}_{c u r rent} - A J {D}_{p r e v i o u s}}{A J {D}_{p r e v i o u s}} \qquad ( 1 )$$

wherein AJD_{current} is the value of the joint axial separation distance (AJD) in the current image frame and AJDₚᵣₑᵥᵢₒᵤₛ is the joint axial separation distance in the previous image frame.

The percent change in Equation (1) can be a positive or negative value. If it is a positive value, this may indicate that that subject is approaching the imaging sensor 506, and therefore the size of the separation distances appears larger. If the subject is approaching the imaging sensor, this indicates that their head is occupying a larger proportion of the image frame, and a larger facial mask is required. In contrast, if the percent change is negative, this may indicate that subject is becoming more distant to the imaging sensor 506, and therefore the size of the separation distances appears smaller. If the subject is distancing from the imaging sensor, this indicates that their head is occupying a smaller proportion of the image frame, and a smaller facial mask is required.

In other examples, Equation (1) can be used with any other form of axial distance metric. For example, the equation can be used to determine the change between averaged axial distances in the current image frame as compared to the prior image frame.

In at least one example, an advantage of using the axial distance with the largest change, as the axial distance metric at 210b and 212b, is that it represents an accurate proxy for the changing size of the subject's head in the image frame, and it is computationally simple to identify the axial distance with the largest change (e.g., as compared to averaging the distances).

At 214b, the size dimensions of the facial mask are adjusted from the previous image frame, and by the corresponding change determined in Equation (1).

In some examples, act 214b involves: (i) determining one or more size dimensions of the facial mask applied in the previous image frame (e.g., the same previous image frame referenced in act 206b); and (ii) adjusting each of the size dimensions by the percent ratio value determined at act 212b.

By way of example, if the facial mask is a circle defined by a diameter “x” in the previous image frame, then in the current image frame, the diameter of the facial mask is increased or decreased by % change “y” in accordance with Equation (1). Accordingly, the dimensions of the facial mask are adjusted incrementally, between image frames, by the corresponding percent change in Equation (1). The percent change in Equation (1) therefore acts as a proxy to track how much image space is occupied by the subject's head as between image frame.

It will be understood that the size dimensions adjusted at act 214b in FIG. 2B vary based on the shape of applied facial mask. For example, in the case of a 2D circular mask, the size dimensions adjusted in act 214b correspond to the diameter or radius of the facial mask. In other examples, if the facial mask is a 2D rectangle mask, the size dimensions adjusted in act 214b correspond to the height and width of the rectangle. In the case of a 3D image, the size dimensions also correspondingly relate to each 3D dimension of that mask.

In at least one example, at act 214b, the system can (i) first, identify the type of facial mask applied (i.e., the geometric shape of the mask), (ii) second, identify one or more predetermined geometric dimensions associated with that geometric shape; and (iii) third, apply adjustments to each of these dimensions.

Referring back to FIG. 2B, in other cases, if the determination at act 208b is negative, then at 216b, the size dimensions of the facial mask are determined as being the same as the previous image frame. This is because, if there is no change in any of the separation distances, it is assumed that the subject has not changed in position relative the imaging sensor(s) 506. Accordingly, the same size of facial mask can be applied to the current image frame as the previous image frame.

In some examples, if there is no previous image frame to reference in method 200b, then the facial mask is applied with some predetermined default size dimensions. The predetermined default size dimensions may vary proportionality with the separation distances determined at 204b.

For example, it is possible that the system determines the default size parameters for the facial mask by, (i) initially, determining the values for one or more axial separation distances 320a -320c; and (ii) mapping the determined axial separation distances 320 to predefined size parameters for the facial mask (e.g., stored in memory). For instance, each predefined size parameter is associated with values, or value ranges, of axial separation distances 320a-320c.

By way of example, the system can determine that if one or more of the axial separation distances 320a-320c are within value range “x”, then the facial mask should have size dimensions “y”. In this manner, the system accounts for the fact that if the axial separation distances are certain values, or value ranges, it is likely that the subject is closer or farther away from the imaging sensor 506. The system can then map the values to estimated default size dimensions for the facial mask, based on the likelihood that the image head region occupies more or less space in the image frame.

In some cases, the system can also identify the largest separation distance 320a-320c in the image frame, and use that separation distance to determine a default size of facial mask. For example, if the shoulder separation distance 320a is the largest distance, this may be most useful to estimate how close or far the subject is from the imaging sensor 506. In turn, this axial separation distance is used to determine a default size for the facial mask. In other cases, the separation distances can be averaged, or combined in any other suitable manner and correlated to some default size value for the facial mask.

Once acts 214b or 216b are completed, the method 200a can continue to acts 210a and 212a, in FIG. 2A.

A number of advantages of the disclosed method are now explained:

First, as discussed previously, the size of the facial mask is determined based on the joint axial separation distances 320a-320c. The joint separation distances 320a-320c are specifically chosen to accommodate the wide range of physical movement that can cause the subject's head to occupy more or less space within the image frame 302. That is, irrespective of movement performed by the subject, method 200b always detects a change at act 208b (FIG. 2B) in one or more of the shoulder separation distance 320a, hip separation distance 320b and spine separation distance 320c. The following provide some illustrative examples of this concept:

Walking: FIG. 4A exemplifies a use application of method 200b involving a walking subject. In a first image frame 302a, the subject is positioned away from the imaging sensor 506, thereby causing their head region 314 to decrease in proportionate size to the image frame. In the second image frame 302b, the subject is walking towards the imaging sensor 506, thereby causing their head region 314 to gradually increase in relative size.

In this example, applying method 200b, the size of the facial mask increases in the second image frame 302b relative to the first image frame 302a, to accommodate the larger size of the subject's head.

More particularly, in applying method 200b (FIG. 2B), acts 206b-208b identify that each of the joint separation distances 320a-320c increases in the second image frame 302b, relative to the first image frame 302a. This is because, as the subject approaches the imaging sensor 506, each of the shoulder, hip and axial separation distances 320 proportionality increases. In turn, the size of the facial mask—determined at acts 212b and 214b in FIG. 2B, and using Equation (1)—increases in the second image frame 302b, and in proportion to the change in the separation distances 320a-320c. The joint axial separation distance 320a-320c therefore each act as a proxy to determine the change in the size of the subject's head between image frame, and to vary the size of the facial mask in proportion.

It is understood that in the example of FIG. 4A, if the subject is walking away from the imaging sensor, method 200b would decrease the size of the facial mask because the joint separation distances 320 would decreases in size. Further, it is also appreciated that, irrespective of where the subject 106 is walking or located in the image frame, the location of their head region 314 is always tracked using the location of their spinal axis 350c and sternal notch, as identified via joint detection (e.g., acts 204a and 206a in FIG. 2A).

Torso or Hip Twisting: FIG. 4B exemplifies another use application for method 200b. In this example, the physical activity involves twisting or rotating the hip or torso. As the subject rotates away from the camera in the second image frame 302b, the size of their head region 314 decreases relative to the first image frame 302a.

In this example, acts 206b-210b in method 200b (FIG. 2B) would identify a significant change in the shoulder axial separation distance 320a. This is because, as the subject rotates their hip or torso, the size of shoulder axial separation distance 320a experiences the largest change between image frames, e.g., relative to the perspective view of imaging sensor 506. Accordingly, the system relies on the shoulder axial separation distance 320a as a proxy for adjusting the size of the facial mask applied to the head region 314.

Lean Forward Exercises: FIG. 4C exemplifies still another use application for method 200b. In this example, the physical activity involves a forward lean, towards the imaging sensor 506. As the subjects leans towards (or away) from the imaging sensor 506, the size of the subject's head increases or decreases proportionally.

In this example, the spinal separation distances 320c decreases when the subject leans forward, and increases when the subject leans backward. Accordingly, acts 206b-210b in method 200b (FIG. 2B) would identify a significant change in the shoulder axial separation distance 320a, and adjust the facial mask size accordingly.

Supine Exercises: FIG. 4D exemplifies a further application for method 200b where the physical activity involves the subject being in a supine position. In this example, the subject transitions from a forearm plank in a first image frame 302₁, to a side plank in a second image frame 302₂.

It is observed that, when the subject is in a forearm plank (302₁), the hip and shoulder axial separation distances 320a, 320b are minimal relative to the spinal separation distance 320c. This is because from a side view, the hip and shoulder axial separation distances 320a, 320b are not observable.

To this end, when the subject is in the forearm plank (3021), the head region 314 occupies a smaller proportion of the image frame, owing to the fact that only the side profile of the user's head is visible to the camera.

In contrast, when the subject transitions to the side plank (302₂), the subject's face now occupies a larger proportion of the image frame, as the subject's face is now directed towards the imaging sensor. Further, a change is observed in the shoulder distance 320a and the hip distance 320b, as they are now also visible to the camera.

In this example, the shoulder distance 320a exhibits the largest change between image frame 302₁ and 302₂. Accordingly, acts 206b-210b in method 200b (FIG. 2B) identify a significant change in the shoulder axial separation distance 320a, and adjust the facial mask size based on this axis. FIG. 4D therefore exemplifies the application of the disclosed methods to supine activities.

In view of the foregoing, as stated previously, method 200b relies on the shoulder, hip and spinal joints as the basis for generating the axis lines 320a-310c because, irrespective of the type of physical activity performed by the user—i.e., including both stationary and dynamic activity—at least one of these axis lines is visible in the image frame, and varies based on the type of human motion. In this manner, as noted previously, joint axis lines 320a-320c act as a reliable proxy for changes in the subject's head size relative to the image frame, and consequently, the size adjustment to be applied to the facial mask.

A further advantage of the disclosed examples is that they involve low processing complexity. For example, method 200b does not rely on computationally intensive algorithms that detect imaged facial features to both track the subject's face location in the image frame, and apply the correct sized facial mask. Rather, the disclosed method relies on a simplified technique that: (i) tracks the subject's head location 314 using the spinal axis 350c and sternal notch joint; and (ii) adjusts the size of the facial mask incrementally and proportionately between image frames, rather than recomputing the size of the facial mask for each new image frame.

Because of its low computational complexity, method 200b also does not suffer from processing lag or delay, and can be applied in real time or near real time. For example, the facial mask can be applied to each image frame as it is generated. This enables displaying and/or transmitting real time or near real time masked images (FIG. 1). The low processing complexity also enables applying real time or near real time facial masks to subjects performing “explosive” physical movements between rapidly generated image frames, and without processing lag.

### (iii.) Analyzing Multiple Subjects in an Image Frame

Still another advantage of the disclosed methods is that they can be applied to image frames that include multiple subjects.

For example, in at least one example, after act (202a) in FIG. 2A, the system can initially analyze the image frame to identify one or more skeletal outlines e.g., using the skeletal SDK described in act 204a in FIG. 2A). Each skeletal outline can designate a separate individual in the image frame. In this examples, acts (204a)-(212a) can be applied to each identified individual, via their corresponding skeletal outline and associated joints. In this manner, facial masking is applied appropriately to each subject using methods 200a and 200b. This also enables real time or near real time facial masking in scaled up applications where multiple subjects are imaged. This is contrasted to conventional techniques, where adding more subjects in an image can overwhelm processing capabilities as complex algorithms are multiplied for each new imaged subject in the frame.

### (iv.) Analyzing Masked Image Frames for Physical Activity Assessment

As discussed previously, at least one use application for the masked image frames—generated in FIGS. 2A and 2B—is that it allows for third party users to analyze the physical activity performed by the subject, while maintaining the subjects privacy. Because only the subject's face is masked, the remaining portions of the body are still visible in the image for analysis. This, in turn, allows for identifying movement dysfunctions by analyzing the masked image frames. In at least one example, the analysis of the subject's physical form is performed automatically using computer image analysis.

FIG. 2C shows a method 200c for processing image frames to analyze a physical activity performed by a subject.

Method 200c can be executed by at least one processor of one or more computing devices including user device 102, external server 104 and/or remote computing device 112 (FIG. 1).

At 202c, the masked image frame is analyzed to extract one or more “physical activity feature” data. “Physical activity features” broadly relate to any aspect of the subject's physical body form. For example, these relate to the pose or motion of the subject's body as they are performing a physical exercise.

In some examples, the physical activity features are determined using the same joint axial lines 350a-350c, joint axial separation distances 320a-320c, and joint position 304-308 locations used to generate the facial mask. This allows the axial lines 350, separation distances 320 and joint positions to be used for the dual purpose of (i) generating the masked image frame, and (ii) determining the physical activity features of the imaged subject.

To this end, in method 200c, the system can retrieve the joint analysis data associated with an image frame, in order to access data related to the joint axis lines 350, joint separation distance 320 and joint locations 304-308.

Various physical activity features are determinable, at 202c, based on the joint analysis data, including the following non-exhaustive list:

(i) Symmetry Features: For certain exercises, it is necessary that that the subject is performing the exercise while maintaining physical symmetry. The axial lines 350 and separation distances 320, in the masked image frame, can be analyzed to determine different types of symmetry properties.

For instance, in FIG. 4C, as the subject is leaning forward, it is necessary that the right and left shoulder joints 304a, 304b (FIG. 4A) are equidistant from the spinal axis line 350c. The same is also said of the right and left hip joints 306a, 306b, which also need to be equidistant from the central spine axis 350c.

In this example, to determine symmetry, the system can access the joint analysis data and (i) determine the point of intersection of the spine axis line 350c with the hip and shoulder joint axis lines 350a, 350b, and further (ii) determine if each of hip and shoulder joints are equidistant from the spine axis line 350c.

(ii) Variation in Axial Separation Distance Features: The axial separation distances 320 are also useful to determine if the subject is performing a motion correctly.

In FIG. 4B, for example, when the subject is performing a torso rotation, only the shoulder distance 320a should vary (or change) between image frames. In contrast, the spinal distance 320c and hip distance 320b should generally remain constant. Accordingly, the system can analyze image frames to identify the axial distances which are changing and/or remaining constant, using the joint analysis data.

In some examples, the system can also analyze the joint analysis data to determine that the axial distances are changing in the correct manner or direction, as between image frames. For instance, in FIG. 4B, as the subject is rotating their torso in a first direction, it is expected that shoulder axial distance 320a should continuously decrease in size between image frames. Thereafter, when the subject switches and rotates in a second and opposite direction, it is expected that the shoulder axial distance 320a should progressively increase in size until the subject is back at the default resting position (e.g., in image frame 302a of FIG. 4B). Thereafter, the shoulder axial distance 320a should again decrease as the subject continues their rotation in the opposite direction and away from the image sensor lens.

As such, the system can track changes in axial distances 320, between image frames, to determine if these distances are increasing or decreasing as expected. In at least one example, the system can track changes in axial distances 320 using the same output of Equation (1) at acts 208b and 210b (FIG. 2B). Equation (1) provides the percent change of axial distance between image frames. Equation (1) can therefore be used for the dual purpose of (i) determining the size of the facial mask, as well as (ii) monitoring the rate of change of axial distances 320, e.g., to determine if they are varying in the correct manner. In some examples, the joint analysis data also includes the result or output of Equation (1) such that the output of Equation (1) can be used in method 200c.

In view of the foregoing, changes in axial separation distances 320 can be used by a user (e.g., a medical practitioner) to determine if a subject is performing a motion exercise correctly.

(iii) Relative Joint Axis Alignment Feature: Still another feature that can be assessed based on the joint analysis data is how the joint axis lines are aligned and/or separated (e.g., relatively or absolutely).

For example, in FIG. 4B, it should be expected that, through the range of torso rotation, the shoulder joint axis line 350a should remain parallel and spaced from the hip joint axis line 350c. Accordingly, the system can analyze the image frame to monitor the relative orientation and separation distances between axial lines.

(iv) Joint Position Features: The system can also use the pixel locations of the identified joints 304-308.

For instance, in FIG. 4B, it should be expected that while the subject is performing the torso rotation—the two spinal joints 308a, 308b should remain on top of each other. This indicates that the spine axis 350c is in a correct vertical position through the range of motion. Accordingly, the joint positions can indicate whether the corresponding joint axis 350a-350c is in the correct orientation (e.g., vertical, horizontal or tilted).

In another example, the joint position features can also indicate whether certain joints are in the correct position relative to other joints. For example, in FIG. 4C, a correct lean posture may require the shoulder joints are vertically aligned with the corresponding hip joints.

Returning to FIG. 2C, at 204c, one or more outputs are generated, whereby such outputs are associated with the physical activity feature data. The disclosure herein is not limited to the type of generatable output.

The output can be, for example, a numerical value. For example, if symmetry features are extracted, then the output can correspond to various symmetry values indicating the distance of the shoulder and hip joints from the central spine axis 350c. The output can also be a binary indicator, indicating whether or not certain joints are symmetrically positioned. In other examples, if joint axis alignment features are extracted, the output can correspond to a value indicating how different axis are oriented relative to other axis.

The outputs can be displayed on a display interface, e.g., of user device 102 and/or computing device 112. For example, as each masked image frame is displayed, the corresponding physical activity feature data is displayed in association with the masked image frame. This may allow a user (e.g., a rehabilitation practitioner) to manually and visual assess the subject's performance of the exercise based on the physical activity feature data. This may allow the practitioner to evaluate different motion dysfunctions and the like, using masked image frames of subjects.

FIG. 2D shows another method 200d for processing image frames to analyze a physical activity performed by a subject. Method 200d can allow determining whether a particular physical activity is being performed correctly.

Method 200d can also be executed by at least one processor of one or more computing devices including user device 102, external server 104 and/or remote computing device 112 (FIG. 1).

At 202d, the system can identify the physical activity being assessed. By way of example, a user (e.g., rehabilitation actioner) can input the activity type into a computing device. The activity can be input into an input interface, e.g., of user device 102 or computing device 112. This can be the activity the user wants to evaluate is being performed correctly by the subject. In other examples, the system is preprogrammed to assess only a specific type of activity.

At 204d, one or more physical activity feature rules, associated with a physical activity are determined.

In at least one example, the system stores a set of predefined or predetermined feature rules in respect of each physical activity type. The feature rules can define the physical activity features that should hold true if the physical activity is performed correctly in the masked image frame.

For instance, in FIG. 4B, the feature rules-which indicate that a torso rotation is being performed correctly—include that: (i) the spine axial separation distance 320c, and hip axial distance 320b, are constant between image frames; (ii) the spine axial line 350c is in a vertical orientation, and the hip axis line 350b is in a horizontal orientation, as determined based on the joint position 304-308 locations; (iii) the shoulder axial distance 320a is the only separation distance varying between image frames, and it varies according to the pattern of gradually decreasing, increasing then decreasing, e.g., with rotation; (iv) the shoulder axial line 350a is parallel and spaced from the hip axial line 350b; and (vi) there is symmetrical spacing of the hip joints 306a, 306b relative to the spine axial line 350c through the range of motion. Accordingly, the feature rules represent a collection of physical feature data that indicate a torse rotation exercise is performed properly. A similar set of rules can be predefined for different activity types.

Therefore, for different physical activities, the system can store associated predefined (or predetermined) feature rules that indicate whether the exercise is performed correctly. In some examples, system stores reference data (e.g., a lookup table) that includes each physical activity, and its corresponding physical activity feature rules. This reference data is stored, for example, on a memory of one or more of the user device 102 (e.g., memory 504), external server 104 and/or external computing device 112.

Here, it will be appreciated that each of the feature rules is assessed based on the same joint analysis data used to generate the facial mask, e.g., the axial lines 350, axial separation distances 320 and locations of joints 304-308.

At 206d, the system analyzes the masked image frames to extract physical feature data. This can be analogous to act 202c (FIG. 2C). In some examples, the system only extracts physical feature data that is relevant to the feature rules determined at 204d.

At 208d, the system determines if the physical activity features rules are satisfied, based on the extracted feature data. In other words, the system compares the extracted feature data to the feature rules to determine a match (i.e., that the analyzed features correctly reflect the required feature rules). For instance, in the example of FIG. 4B, this involves determining whether the feature data indicates that the spine axial separation distance 320c, and hip axial distance 320b, are constant between image frame, and so on.

At 210d, if there is a match, the system can generate a positive output indicating that the physical activity is being performed correctly. In some case, the system determines that the physical activity is performed correctly if each feature rule is satisfied. In other cases, only a minimum threshold of feature rules need to be satisfied for a positive output. The output can be any form of output, including stored data or visual output.

Otherwise, at 212d, the system can generate a negative indication that the physical activity is being performed incorrectly.

In some examples, the output at 212d may include an indication of what corrective movement the user has to undertake to perform the activity correctly. For example, the system can determine which feature rules were not satisfied at 208d (e.g., symmetry). The system may then indicate to the user that these feature rule were not satisfied and/or corrective actions the subject must undertake to satisfy these feature rule. For example, the system may suggest that the subject should must maintain symmetry between specific joints.

The masked image frame may be stored in association with the outputs generated at 204c, 208d and/or 210d. For example, the output can be stored separately in association with one or more masked image frames, or otherwise embedded into the masked image frames (e.g., as metadata). The masked image frame and associated output data may then be accessed and/or transmitted to allow users to view the anonymized images and associated output data.

In view of the foregoing, it is appreciated that an advantage of methods 200c and 200d is that the physical activity performed by the subject is analyzed using the same elements (i.e., joint analysis data) used for generating the facial mask, namely: the joint axis lines 350, joint axial separation distances 320 and the joint location position 304-308. By “reusing” the same data for both facial mask generation and automated physical activity analysis—computational complexity is reduced because the two analyses are not determined by separate computational processes (or algorithms). This allows anonymizing/masking images, all the while evaluating the anonymized images to assess physical activity performance. The use of joint axis lines, joint separation distances and joint positions is therefore well suited for specific applications of facial identity masking in the context of physical activity assessment of subjects. As evident from the above discussion, the joint axis lines 350, joint axial separation distances 320 and the joint location position 304-308 are useful to analyzing a wide range of different types of physical activities since they capture the primary components of body motion, e.g., hip, spine and shoulder movement (see e.g., FIGS. 4A-4D), and for a wide range of exercises.

In some examples, the system performs facial masking (FIGS. 2A-2B) and physical activity analysis (FIGS. 2C-2D) concurrently, or partially concurrently. For instance, as the system is processing and analyzing the axial lines 350 and axial separation distances 320 to generate the facial mask, it may concurrently (or partially concurrently) also process and analyze this data to execute methods 200c and/or 200d. This reduces processing time by taking advantage of the fact that the facial mask and physical activity features are determined by common computational processes.

In at least one example, methods 200c and/or 200d are performed in real time or near real time. For instance, the system can analyze a subject's activity in real time or near real time, based on captured image frames. More generally, the system can apply, in real time or near real time, the facial masking (FIGS. 2A-2B) as well as analyzing image frames for the subject's physical activity performance (FIGS. 2C-2D).

In other examples, the system can perform methods 200c and/or 200d after the fact. For example, the masked image frames can be transmitted to the external server 104 and/or user device 112, e.g., as an output at act 212a. The masked image frame can be transmitted in conjunction with various joint analysis data. This allows an external computing device to perform methods 200c and/or 200d using the image frame and joint analysis data. For instance, a user of remote device 112 (e.g., a medical practitioner) can receive the image frames. The user can input a desired physical activity to monitor at 202d, and the external computing device can use the analysis data, associated with each image frame, to execute method 200d. The user can repeat the same routine while inputting different activity types at 202d, and the system can reanalyze the same masked image frames for performance of that activity type, in accordance with FIG. 2D.

In at least one example, the analysis performed on the masked image is analogous to the analysis performed in Comeau. It is appreciated that the analysis in Comeau also relies on defining at least shoulder and hip joint axis lines, among other axis lines, to determine if the posture and form of the exercise is performed correctly. Accordingly, the disclosed method of facial masking is adapted for concurrent facial masking, as well as analysis of the image to determine if the activity is performed correctly.

### (v.) Other Applications

While the method of facial masking described in FIGS. 2A and 2B has been explained primarily in the context of physical activity assessment-the same methods of facial masking can be applied in a wide array of other applications that require user privacy, e.g., in real time or near real time. For example, this can involve applying facial masking to image frames generated during live video conference calls, including general video conference calls (e.g., Zoom™, or Apple™ FaceTime™), or telehealth calls between doctors and patients. As discussed above, the low computational complexity of methods 200a and 200b enable them to be applied readily for real time or near real time image facial masking applications. Accordingly, the disclosed methods are not limited to any specific context, use or application.

### III. EXAMPLE HARDWARE ENVIRONMENT

Reference is now made to FIG. 5, which shows an example simplified hardware block diagram for a user device 102. While not explicitly shown, the server 104 and external computing device 112 may have an analogous architecture.

As shown, the user device 102 generally includes a processor 502 coupled to one or more of a memory 504, one or more imaging sensor(s) 506, a display interface 508, communication interface 510 and a user input interface 512. The components may be coupled via a computer data bus 550.

Processor 502 is a computer processor, such as a general-purpose microprocessor. In some other cases, processor 502 may be a field programmable gate array, application specific integrated circuit, microcontroller, or other suitable computer processor. In some cases, processor 502 may comprise multiple processors, such that is referenced as at least one processor 502.

Processor 502 is coupled, via a computer data bus, to memory 504. Memory 504 may include both volatile and non-volatile memory. Non-volatile memory stores computer programs consisting of computer-executable instructions, which may be loaded into volatile memory for execution by processor 502 as needed. In some examples, memory 504 stores instructions for executing any one of, or any portion of, the methods 200a-200c (FIGS. 2A-2C). Memory 504 can also store various software development kits (SDKs) and other programs, e.g., skeletal SDK, as disclosed herein.

It will be understood by those of skill in the art that references herein to user device 102 as carrying out a function or acting in a particular way imply that processor 502 is executing instructions (e.g., a software program) stored in memory 504 and possibly transmitting or receiving inputs and outputs via one or more interfaces. Memory 504 may also store data input to, or output from, processor 502 in the course of executing the computer-executable instructions.

Imaging sensor(s) 506 can include one or both of 2D and 3D imaging sensors. Two-dimensional (2D) image sensor(s) can comprise any sensors capable of capturing 2D images. For example, this can include any type of camera, or the like (e.g., RGB cameras). Three-dimensional (3D) image sensor(s) can comprise any sensors capable of capturing 3D data. For example, this can include various types of depths sensors, including LiDAR sensors, as known in the art.

Display interface 508 is a suitable display for outputting information and data as needed

by various computer programs.

Communication interface 510 is one or more data network interface, such as an IEEE 802.3 or IEEE 802.11 interface, for communication over a network.

Input interface 512 may be, for example, a keyboard, mouse, etc. In some cases, display 512 may act as an input interface 514 where the display 512 is a touch-screen display (e.g., a capacitive touchscreen display).

### IV. INTERPRETATION

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for applying facial image masking of a subject performing a physical activity, the method comprising:
analyzing an image frame of the subject to identify one or more target joints and their locations;
generating joint axis lines that intersect locations of joints of the same type;
determining joint axial separation distances for the joint axis lines;
determining size dimensions for a facial mask by:
determining a degree of change for an axial distance metric between the image frame and a previous image frame, wherein the axial distance metric is associated with the joint axial separation distances; and
adjusting the size dimensions of the facial mask applied in the previous image frame in proportion to the degree of change, to generate updated size dimensions for the facial mask;
generating a masked image frame by applying the facial mask, with the updated size dimensions, to a head image region of the subject in the image frame; and
outputting the masked image frame.

2. The method of claim 1, further comprising:
initially, operating an imaging sensor to capture the image frame.

3. The method of claim 2, wherein the imaging sensor is one or more of a two-dimensional (2D) imaging sensor and a three-dimensional (3D) imaging sensor.

4. The method of claim 1, wherein,
the target joints comprise at least a pair of (i) shoulder joints, (ii) hip joints and (iii) spine joints; and
the joint axis lines comprise (i) a shoulder joint axis line, (ii) a hip joint axis line, and (iii) a spine joint axis line.

5. The method of claim 4, further comprising, initially, determining a location of the head image region, corresponding to a location of the subject's head in the image frame.

6. The method of claim 5, wherein the spine joints include a sternal notch joint, and the head image region corresponds to the region along the spinal axis above the sternal notch joint.

7. The method of claim 1, wherein the analyzing the image frame to identify the one or more target joint types comprises processing the image frame using a skeletal software development kit (SDK).

8. The method of claim 1, wherein prior to the comparison:
determining if there is a change between the joint separation distances in the image frame and the previous image frame; and
if there is no change, applying the facial mask with the size dimensions in the previous image frame.

9. The method of claim 1, wherein outputting the masked image frame comprises one or more of: (i) displaying the masked image frame in real time or near real time on a computing device, and (ii) transmitting the masked image frame to a cloud server.

10. The method of claim 1, further comprising analyzing the masked image frame for one or more physical activity parameters, using the joint axis lines.

11. A system for applying facial image masking of subjects performing physical activities, the system comprising
at least one image sensor configured to capture an image frame of the subject; and
at least one processor coupled to the at least one image sensor, the at least one processor configured for:
analyzing the image frame of the subject to identify one or more target joints and their locations;
generating joint axis lines that intersect locations of joints of the same type;
determining joint axial separation distances for the joint axis lines;
determining size dimensions for a facial mask by:
determining a degree of change for an axial distance metric between the image frame and a previous image frame, wherein the axial distance metric is associated with the joint axial separation distances; and
adjusting the size dimensions of the facial mask applied in the previous image frame in proportion to the degree of change, to generate updated size dimensions for the facial mask;
generating a masked image frame by applying the facial mask, with the updated size dimensions, to a head image region of the subject in the image frame; and
outputting the masked image frame.

12. The system of claim 11, wherein the at least one processor is further configured for:
initially, operating the imaging sensor to capture the image frame.

13. The system of claim 11, wherein the imaging sensor is one or more of a two-dimensional (2D) imaging sensor and a three-dimensional (3D) imaging sensor.

14. The system of claim 11, wherein,
the target joints comprise at least a pair of (i) shoulder joints, (ii) hip joints and (iii) spine joints; and
the joint axis lines comprise (i) a shoulder joint axis line, (ii) a hip joint axis line, and (iii) a spine joint axis line.

15. The system of claim 14, wherein the at least one processor is further configured for: initially, determining a location of the head image region, corresponding to a location of the subject's head in the image frame.

16. The system of claim 15, wherein the spine joints include a sternal notch joint, and the head image region corresponds to the region along the spinal axis above the sternal notch joint.

17. The system of claim 11, wherein the analyzing the image frame to identify the one or more target joint types comprises processing the image frame using a skeletal software development kit (SDK).

18. The system of claim 11, wherein prior to the comparison, the at least one processor is further configured for:
determining if there is a change between the joint separation distances in the image frame and the previous image frame; and
if there is no change, applying the facial mask with the size dimensions in the previous image frame.

19. The system of claim 11, wherein outputting the masked image frame comprises the at least one processor being further configured for one or more of: (i) displaying the masked image frame in real time or near real time on a computing device, and (ii) transmitting the masked image frame to a cloud server.

20. The system of claim 11, further comprising the at least one processor being configured for: analyzing the masked image frame for one or more physical activity parameters, using the joint axis lines.
